(19) United States
(12) Patent Application Publication
(10) Pub. No.: US 2024/0356091 A1
(43) Pub. Date: Oct. 24, 2024

(54) BATTERY SYSTEMS UTILIZING ASYMMETRIC CONFIGURATIONS OF MULTIPLE CELL BLOCKS AND METHODS RELATED TO SAME

(71) Applicant: DELL PRODUCTS L.P., Round Rock, TX (US)

(72) Inventors: Rick C. Thompson, Cedar Park, TX (US); Jui Chin Fang, Taipei City (TW); Wen-Yung Chang, Taoyuan City (TW)

(21) Appl. No.: 18/136,877

(22) Filed: Apr. 20, 2023

(51) Int. Cl. H01M 10/42; H01M 50/509

(52) U.S. Cl. CPC H01M 10/4257; H01M 50/509; H01M 2010/4271

(57) ABSTRACT

Battery systems and related methods are provided in which a single battery system may be implemented to have an asymmetric configuration of multiple battery cell blocks that each have the same block charge capacity, and in which all of the battery cell blocks of the single battery system taken together form the asymmetric configuration of multiple battery cell blocks. Each of the multiple battery cell blocks of a single battery system (e.g., battery pack) may be configured with one or more battery cells, the multiple battery cell blocks may be electrically coupled together in series, and at least a first one of the multiple battery cell blocks may have a first internal battery cell configuration that is different from a second internal battery cell configuration of at least a second one of the other multiple battery cell blocks of the same battery system.

### FIELD

This invention relates generally to information handling systems and, more particularly, to battery systems for information handling systems.

### BACKGROUND

As the value and use of information continues to increase, individuals and businesses seek additional ways to process and store information. One option available to human users is information handling systems. An information handling system generally processes, compiles, stores, and/or communicates information or data for business, personal, or other purposes thereby allowing human users to take advantage of the value of the information. Because technology and information handling needs and requirements vary between different human users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific human user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In the past, sub-optimal layouts of information handling system components have been employed in order to provide acceptable space to enable use of an available conventional-sized battery pack. To fit space within an information handling system, available conventional battery packs having sub-optimal performance have also been employed to fit available space within an information handling system. Battery packs with multiple different battery cell sizes have been provided, where each of the multiple different battery cell sizes has the same cell charge capacity as the other multiple different battery cell sizes. Battery packs have also been provided with irregular-shaped cells in an attempt to optimize product industrial design, or in an attempt to better utilize space within an information handling system that is available to the battery pack.

It is also known to develop or specify the development of a new battery pack (or new cells configured into a battery pack) in parallel with the development of a new information handling system, based on conventional architectures and methods, that results in sub-optimal information handling system layout due to conventional battery pack design limitations.

### SUMMARY

Disclosed herein are battery systems and related methods in which a single battery system may be implemented to have an asymmetric configuration of multiple battery cell blocks that each have the same block charge capacity (e.g., each of the battery cell blocks may have the same watt-hour capacity as each other), and in which all of the battery cell blocks of the single battery system taken together form the asymmetric configuration of multiple battery cell blocks (i.e., the asymmetric configuration of multiple battery cell blocks includes all of the battery cell blocks of the single battery system). In the disclosed battery systems, each of the multiple battery cell blocks of a single battery system (e.g., battery pack) may be configured with one or more battery cells, the multiple battery cell blocks may be electrically coupled together in series, and at least a first one of the multiple battery cell blocks may have a first internal battery cell configuration that is different from a second internal battery cell configuration of at least a second one of the other multiple battery cell blocks of the same battery system.

In one embodiment, the multiple battery cell blocks of a single battery system may be positioned or arranged such that the overall configuration of all of the battery cell blocks of the single battery system taken together is asymmetric, e.g., has no axis of length or width symmetry with regard to battery cell physical size (battery cell shape and/or battery cell physical dimensions of length, width and height) and/or battery cell charge capacity of the battery cells within the battery cell blocks. In one embodiment, the multiple battery cell blocks of the configuration of multiple battery cell blocks may be positioned or arranged such that the overall configuration of all of the battery cell blocks of the single battery system taken together is asymmetric about a centerline that extends through the length or width of the configuration of all of the battery cell blocks of the battery system. In one embodiment, the multiple battery cell blocks may be positioned or arranged such that the overall configuration of all of the battery cell blocks of the single battery system taken together is asymmetric about any line that extends through the length or width of the multiple cell block configuration. In one embodiment, the multiple battery cell blocks may be positioned or arranged such that the overall configuration of all of the battery cell blocks of the single battery system taken together is asymmetric about any line extending through any serial electrical coupling (e.g., serial electrical connection) between any two adjacent multiple battery cell blocks of the configuration of multiple battery cell blocks, with the line so extending to separate the internal battery cell configuration of a first battery cell block from the different internal battery cell configuration of an adjacent serially coupled second battery cell block battery system.

The disclosed battery systems may be advantageously implemented to provide alternate configurations of battery cells for battery systems (e.g., battery packs), to provide improved battery system layout efficiency and improved utilization of space within an information handling system. and to provide improved battery performance advantage in mobile electronics, without the past need for employing sub-optimal layouts of information handling system components required to provide acceptable space to enable use of a conventional-sized battery pack, and without the need for employing conventional battery packs of the past that have sub-optimal performance (e.g., reduced charged capacity) to fit available space within an information handling system. In one embodiment, combinations of differently-shaped and/or differently-physical sized battery cell blocks (e.g., that each have single cells and/or multiple mixed individual cell physical sizes and/or mixed individual cell charge capacities) may be implemented in asymmetric configurations such as described above to enable use of an inventory of existing or currently-available battery cell physical size/s and charge capacity/ies in multiple different battery system (e.g., battery pack) shapes and form factors that would not otherwise be possible, thus enabling supply and manufacturing cost benefits.

In one embodiment of the disclosed battery systems, at least a first one of the multiple battery cell blocks of a single battery system (e.g., battery pack) may have a first internal battery cell configuration that includes multiple battery cells that are electrically coupled together in parallel, and at least a second one of the other multiple battery cell blocks of the same single battery system may have a second internal battery cell configuration that includes only a single battery cell. In this embodiment, the first and second battery cell blocks may be electrically coupled together in series within the same single battery system. In one embodiment, the first battery cell block may be positioned nearer a first end of the battery system, and the second battery cell block may be positioned nearer an opposing second end of the battery system, e.g., such that that the overall configuration of all of the battery cell blocks of the single battery system taken together is asymmetric (or lacks symmetry) about any line that extends through the length or width of the configuration of all of the battery cell blocks of the single battery system to separate the first battery cell block from the second battery cell block.

In another embodiment, at least a first one of the multiple battery cell blocks of a single battery system (e.g., battery pack) may have a first internal battery cell configuration of multiple battery cells that are electrically coupled together in parallel, and at least a second one of the multiple battery cell blocks of the same single battery system may have a second internal battery cell configuration of multiple battery cells that is different from the first internal battery cell configuration, e.g., the second internal battery cell configuration may include a different number of battery cells than the number of battery cells included in the first internal battery cell configuration and/or the second internal battery cell configuration may include at least one battery cell that differs in individual battery cell charge capacity and/or individual cell physical size (physical shape and/or physical dimensions) from the individual battery cell charge capacities and/or individual cell physical sizes of the battery cells of the first configuration. In this embodiment, the first and second battery cell blocks may be electrically coupled together in series within the same single battery system and such that the overall configuration of all of the battery cell blocks of the battery system taken together is asymmetric (or lacks symmetry) about any line that extends through the length or width of the configuration of all of the battery cell blocks of the single battery system to separate the first battery cell block from the second battery cell block.

In another embodiment, multiple battery cells of a first one of the multiple battery cell blocks of a single battery system (e.g., battery pack) may be of the same individual cell physical size (same shape and physical dimensions) as each other or may be of different individual cell physical sizes relative to each other, and may be of the same charge capacity as each other or may be of different charge capacities relative to each other. In this embodiment, at least a second one of the other multiple battery cell blocks of the same single battery system may have the same total block charge capacity as the total block charge capacity of the first battery cell block, and may have at least one battery cell of different individual cell physical size and charge capacity to the individual cell physical sizes and individual cell charge capacities of the multiple battery cells of the first battery cell block, or that includes multiple battery cells that differ in number and individual cell physical sizes to the number and individual cell physical sizes of all the battery cells included in the first battery cell block. In this embodiment, the first and second battery cell blocks may be electrically coupled together in series within the same single battery system and such that the overall configuration of all of the battery cell blocks of the single battery system taken together is asymmetric (or lacks symmetry) about any line that extends through the length or width of the configuration of all of the battery cell blocks of the single battery system of the battery system to separate the first battery cell block from the second battery cell block.

In another exemplary embodiment, a single battery system (e.g., battery pack) may have an asymmetric configuration of multiple battery cell blocks that has a first battery cell block electrically coupled in series to at least a second battery cell block, with the total block charge capacity of the first battery cell block being the same as the total block charge capacity of the second battery cell block. In this embodiment, the first battery cell block may contain multipole battery cells electrically coupled together in parallel that are of a single physical size (i.e., the same physical size to each other) or that are of different physical sizes relative to each other, and/or the multiple battery cells of the first battery cell block may have a same cell charge capacity or may have different cell charge capacities relative to each other. Also in this embodiment, the second battery cell block may contain one battery cell or may contain multiple battery cells that not equal in number to the number of battery cells contained in the first battery cell block, and none of the battery cell/s of the second battery cell block may have the same physical size as the physical size of any of the battery cells contained in the first battery cell block. In this embodiment, the overall configuration of all of the battery cell blocks of the single battery system taken together is asymmetric (or lacks symmetry) about any line that extends through the length or width of the configuration of all of the battery cell blocks of the single battery system to separate the first battery cell block from the second battery cell block.

In one respect, disclosed herein is a battery system, including: multiple battery cell blocks electrically coupled together in series; where all of the battery cell blocks of the battery system together form an asymmetric configuration of multiple battery cell blocks; where each of the battery cell blocks includes one or more battery cells; and where each of the battery cell blocks has a total block charge capacity that is the same as a total block charge capacity of each of the other battery cell blocks.

In another respect, disclosed herein is an information handling system, including: power-consuming circuitry that includes at least one programmable integrated circuit; and a battery system electrically coupled to provide power to the power-consuming circuitry, the battery system including multiple battery cell blocks electrically coupled together in series. In the information handling system, all of the battery cell blocks of the battery system may together form an asymmetric configuration of multiple battery cell blocks. Each of the battery cell blocks of the battery system may include one or more battery cells; and each of the battery cell blocks of the battery system may have a total block charge capacity that is the same as a total block charge capacity of each of the other battery cell blocks of the battery system.

In another respect, disclosed herein is a method, including: manufacturing multiple battery cell types, each of the manufactured multiple battery cell types having at least one of a different respective physical size or a different respective battery cell charge capacity relative to the other manufactured battery cell types; then defining a new battery system architecture for an information handling system that has a limited internal space available for receiving and containing the new battery system architecture, the new battery system architecture having an available battery cell block space and a required total combined battery cell block charge capacity for powering power-consuming circuitry of the information handling system; then comparing the respective physical sizes and the respective battery cell charge capacities of the manufactured multiple battery cell types to the required total combined battery cell block charge capacity and the available battery cell block space of the new system architecture to determine a selected asymmetric battery cell block configuration of the manufactured multiple battery cell types that fit together within the available battery cell block space of the new system architecture and that will provide the required total combined battery cell block charge capacity for powering the power-consuming circuitry of the information handling system; then physically assembling together the manufactured multiple battery cell types of the selected asymmetric battery cell block configuration to form an assembled asymmetric battery cell block configuration including multiple battery cell blocks that are electrically coupled together in series within the limited available internal space of the information handling system, and with the assembled asymmetric battery cell block configuration being electrically coupled to the power-consuming circuitry of the information handling system; and then providing power from the assembled asymmetric battery cell block configuration to operate the power-consuming circuitry of the information handling system. In this method, each of the battery cell blocks of the asymmetric battery cell block configuration may include one or more battery cells; and each of the battery cell blocks of the asymmetric battery cell block configuration may have a total block charge capacity that is the same as a total block charge capacity of each of the other battery cell blocks.

### BRIEF DESCRIPTION OF THE DRAWINGS

FIG. 1 illustrates a block diagram of an information handling system coupled to a power supply according to one exemplary embodiment of the disclosed systems and methods.

FIG. 2 is a block diagram of a battery system according to one exemplary embodiment of the disclosed systems and methods.

FIG. 3A illustrates an overhead view of one exemplary embodiment of an asymmetric battery cell block configuration of a battery system according to one exemplary embodiment of the disclosed systems and methods.

FIG. 3B illustrates an overhead view of one exemplary embodiment of an asymmetric battery cell block configuration of a battery system according to one exemplary embodiment of the disclosed systems and methods.

FIG. 4 illustrates an overhead view of one exemplary embodiment of an asymmetric battery cell block configuration of a battery system according to one exemplary embodiment of the disclosed systems and methods.

FIG. 5 illustrates methodology according to one exemplary embodiment of the disclosed systems and methods.

### DESCRIPTION OF ILLUSTRATIVE EMBODIMENTS

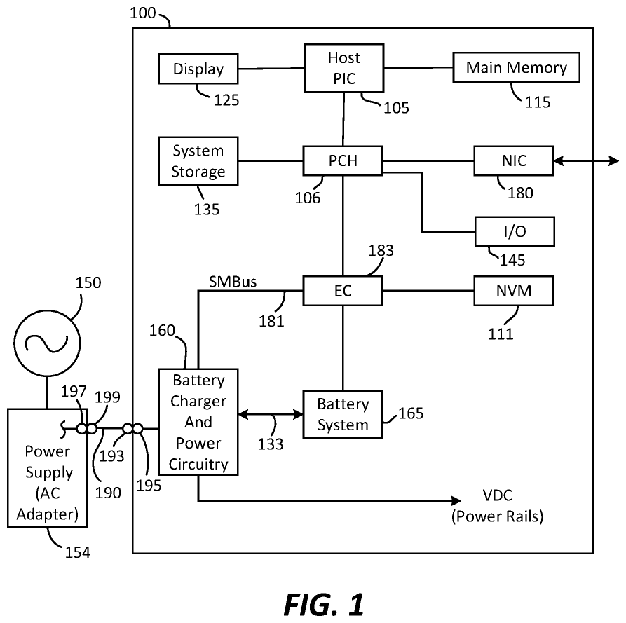

FIG. 1 is a block diagram of a battery-powered information handling system 100 (e.g., mobile portable information handling system such as notebook computer, MP3 player, personal data assistant (PDA), cell phone, smart phone, cordless phone, tablet computer, “2-in-1” or convertible computer, etc.) as it may be configured with various components within an outer chassis enclosure (e.g., tablet computer body or smartphone body, hinged notebook computer base, etc.) according to one exemplary embodiment of the disclosed systems and methods. It will be understood that the embodiment of FIG. 1 is exemplary only, and that other in other embodiments an information handling system may include additional, fewer and/or alternative components suitable for a given application including other programmable integrated circuits such as discrete graphics processing units (GPUs), etc.

As shown in FIG. 1, information handling system 100 of this exemplary embodiment includes a host processing device or host programmable integrated circuit (PIC) 105 (e.g., CPU such as an Intel Pentium series processor, an Advanced Micro Devices (AMD) processor or one of many other processors currently available) coupled to a platform controller hub (PCH) 106. Other examples of programmable integrated circuits 105 include any other suitable one or more programmable integrated circuits such as controller, microcontroller, microprocessor, ASIC, programmable logic device “PLD” such as FPGA, complex programmable logic device “CPLD”, etc.

In the illustrated embodiment, host programmable integrated circuit 105 may be configured to execute an operating system (OS) such as Windows-based operating system, Linux-based operating system, etc. System memory 115 (e.g., DRAM) may be coupled as shown to host programmable integrated circuit 105, and a display device 125 (e.g., LED or LCD display monitor) may be coupled to an integrated graphics processing unit (i-GPU) of host programmable integrated circuit 105 to display visual images (e.g., via graphical user interface) to the user. System storage 135 (e.g., hard disk drive, solid state drive, etc.) may be coupled as shown to host programmable integrated circuit 105 via PCH 106 to provide permanent or non-volatile storage for information handling system 100.

Still referring to FIG. 1, input/output (I/O) devices 145 (e.g., such as a keyboard, touchpad, mouse, etc.) may be coupled via PCH 106 to host programmable integrated circuit 105 to enable the user to interact with the information handling system. In other mobile applications, such as convertible computer, tablet computers and smart phones, a touchscreen may additionally or alternatively be provided for both presenting a graphical user interface (GUI) and for accepting user input. An embedded controller (EC) 183 (e.g., including an integrated programmable integrated circuit such as microcontroller or other processor) may also be coupled to PCH 106 as shown, and may be configured to participate in performance of various tasks such as battery and/or power management, I/O control, etc. Non-volatile memory 111 (e.g., embedded and partitioned flash memory, Electrically Erasable Programmable Read Only Memory—EEPROM, etc.) may be coupled to EC 183 for storing persistent information for EC 183.

In FIG. 1, a network interface (NIF) device 180 may be coupled as shown to host programmable integrated circuit 105 via PCH 106 to enables wired and/or wireless communication with one or more remote network devices or systems across an external network (e.g., wired or wireless local area network, the Internet or a corporate intranet, etc.). In one embodiment NIF 180 may be a network interface controller (NIC), and in another embodiment NIF 180 may also include an optional radio module having at least one antenna element coupled to the radio module for wireless LAN or cellular reception and transmission.

In the embodiment of FIG. 1, information handling system 100 is coupled to an external power supply 154 (e.g., AC adapter) by a power supply cable 190 (e.g., USB Type C cable) that includes multiple electrical conductors (or “lines”) such as at least one DC power conductor (Vbus) and at least one data communication bus conductor. Power supply 154 is in turn coupled to receive AC power from AC mains 150 and to provide DC power to information handling system 100 across the Vbus conductor/s of power supply cable 190. Power supply cable 190 may be, for example, a detachable power supply cable (e.g., USB Type C power supply cable) that is mechanically separable from power supply 154 at mating connectors 197/199 (e.g., USB Type C connectors) and that is also mechanically separable from information handling system 100 at mating connectors 193/195 (e.g., USB Type C connectors). In this way, detachable power supply cable 190 is configured to be temporarily connected to power supply 154 via the mating connectors 197/199 and temporarily connected to information handling system 100 via the mating connectors 193/195, e.g., in a manner that allows an information handling system end user to detach and re-attach the power supply cable 190 at will from power supply 154 and/or information handling system 100. However, in other embodiments, a power supply cable 190 may be an attached power supply cable that is permanently affixed and connected to the power output circuitry of power supply 154, e.g., so that it is not detachable from the power supply 154 by the information handling system end user.

Still referring to FIG. 1, DC power conductor (Vbus) provides DC power received from power supply cable 190 via connectors 193/195 to battery charger/power circuitry (charger) 160 of information handling system 100 to give information handling system 100 a source of DC power to supplement or replace other DC power provided by battery cells of a battery system 165 (e.g., such as self-contained lithium ion (“Li-ion”), nickel metal hydride (“NiMH”), or other type of smart battery pack. Such a smart battery pack 165 may include, for example, multiple blocks of rechargeable battery cells, and a battery management unit (BMU) 266 including an integrated analog front end (“AFE”) coupled to an integrated microcontroller or other programmable integrated circuit. A battery system data bus (SMBus) 182 may also be coupled between battery system 165 as shown to provide battery state information, such as battery voltage and current information, from BMU 266 of battery system 165 to EC 183. In the embodiment of FIG. 1. battery charger/power circuit 160 of information handling system 100 may also provide DC power for recharging battery cells of the battery system 165 during charging operations. In FIG. 1, a data bus (e.g., SMBus) 181 may be coupled between a microcontroller of battery charger/power circuit 160 and EC 183 to allow battery charger/power circuit 160 to exchange information with EC 183.

In one embodiment, when a battery system 165 of information handling system 100 is optionally provided as a replaceable smart battery pack, it may be configured for insertion and removal from a corresponding battery pack compartment defined within the chassis of the information handling system 100 (e.g., such as plastic and/or metal enclosure of a notebook computer, tablet computer, convertible computer smart phone, etc.), and may be provided with external power connector terminal/s for making temporary electrical interconnection with mating power connector terminals within the battery pack compartment to provide power 133 from battery system 165 to the system load (i.e., power-consuming components such as host programmable integraed circuit 105, display 125, system storage 135, EC 183, NIF 180, PCH 106, main memory 115, NVM 111, etc.) of information handling system 100 via battery charger/power circuit 160 and one or more DC power rails 166. The external power connector terminal/s of battery system 165 may also receive power 133 from battery charger/power circuit 160 for charging battery cells of battery system 165. In some embodiments, external power connector terminal/s of battery system 165 may be permanently connected to deliver power 133 to, and receive power 133 from, battery charger/power circuit 160.

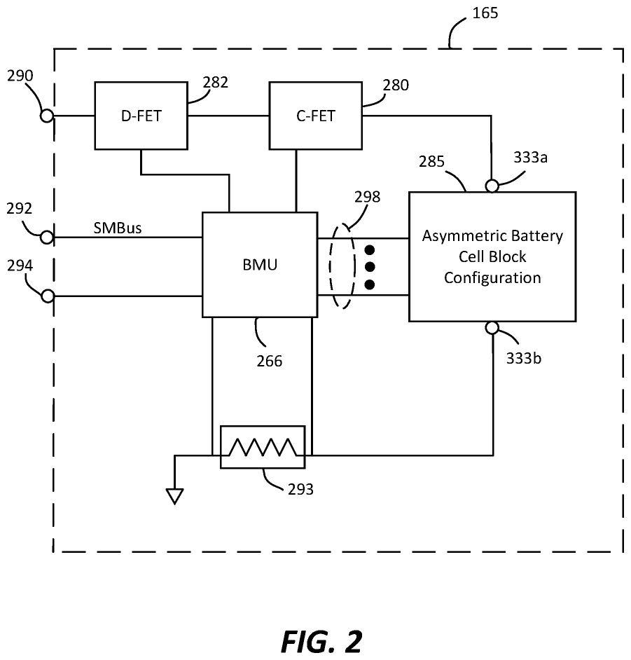

FIG. 2 illustrates one exemplary embodiment of a battery system 165 that is configured in the form of a smart battery pack having an asymmetric configuration 285 of multiple battery cell blocks that each have one or more battery cells, e.g., lithium ion (“Li-ion”) battery cells, nickel metal hydride (“NiMH”) battery cells, nickel cadmium (NiCd) battery cells, lithium-polymer (Li-polymer) battery cells, etc. As shown, battery system 165 of this embodiment also includes a battery management unit (BMU) 266 that may itself include an analog front end (“AFE”) and microcontroller. Battery system 165 may be provided as shown with external power connector terminal 290, external ground connector 294 and data connector terminals (e.g., SMBus) 292 for contacting and making interconnection with corresponding mating power, system ground and data terminals and/or conductors provided within information handling system 100 to provide power to a system load (i.e., power-consuming components) of the information handling system 100 and to exchange data with one or more programmable integrated circuits (e.g., such as EC 183) of information handling system 100.

As shown in FIG. 2, positive and negative electrical terminals 333a and 333b may be provided to electrically couple asymmetric battery cell block configuration 285 to other circuitry of battery system 165. Also in FIG. 2, electrical conductors 298 may be coupled between the battery cell blocks of asymmetric battery cell block configuration 285 and BMU 266 to monitor and convey battery cell status information (e.g., voltage of each battery cell block, total voltage of all the battery cell blocks of the asymmetric battery cell block configuration 285, etc.) to BMU 266 (e.g., to an integrated microcontroller within BMU 266 via an integrated AFE within BMU 266). BMU 266 may also be coupled to a current sense resistor 293 to monitor current flow as shown.

In FIG. 2, battery system 165 may also be provided with charge and discharge circuitry to control flow of charge current to the battery cell blocks of asymmetric battery cell block configuration 285, and to also control flow of discharge current from the battery cell blocks of asymmetric battery cell block configuration 285. In this exemplary embodiment, the charge and discharge circuitry includes two field effect transistors (“FETs”) 280 and 282 coupled in series between battery system terminal 290 and the battery cell blocks of asymmetric battery cell block configuration 285. FET 280 is a charge FET switching element that forms a part of a charge circuit that is controlled by components (e.g., microcontroller and/or AFE) of BMU 266 to allow or disallow charge current to the battery cell blocks of asymmetric battery cell block configuration 285, and FET 282 is a discharge FET switching element that forms a part of discharge circuit that is controlled by components (e.g., microcontroller and/or AFE) of BMU 266 to allow or disallow discharge current from the battery cell blocks of asymmetric battery cell block configuration 285. In FIG. 2, body diodes may be present across the source and drain of each FET switching element, i.e., to conduct charge current to the battery cell/s when the discharge FET switching element 282 is open, and to conduct discharge current from the battery cell/s when the charge FET switching element 280 is open.

It will be understood that charge and discharge circuitry of battery system 165 may include any other number and/or type of charge and discharge switching elements suitable for performing the current control tasks described herein. Examples of types of suitable switching elements include, but are not limited to, bipolar junction transistors (BJTs) and field effect transistors (FETs). Further information on configuration and operation of battery-powered information handling systems, battery systems and smart battery packs, battery charging and discharging operations, charge/discharge FETs, and BMUs may be found, for example, in U.S. Pat. Nos. 7,378,819, 7,391,184, 7,436,149, 7,595,609, 7,619,392, 8,138,722, 8,154,255, 9,015,514, 9,496,932, and 11,495,121, each of which is incorporated herein by reference in its entirety for all purposes.

It will be understood that the particular configuration of components in FIGS. 1 and 2 is exemplary only and that other configurations of fewer, additional and/or alternative components are possible as are appropriate for a given particular type of battery-powered information handling system. It will also be understood that, when present, programmable integrated circuits (such as host processing device 105, EC 183 and a microcontroller of BMU 266) may be communicatively coupled in signal communication with each other using any type of data communication bus or other type of signal communication technology suitable for transferring data therebetween.

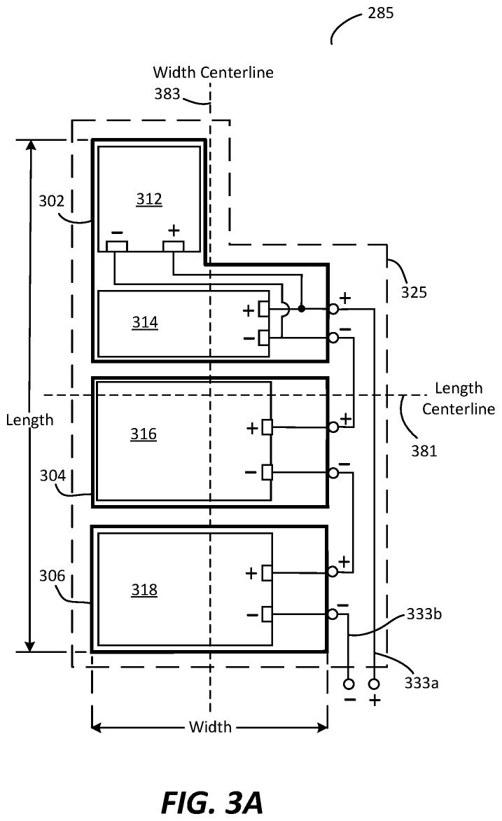

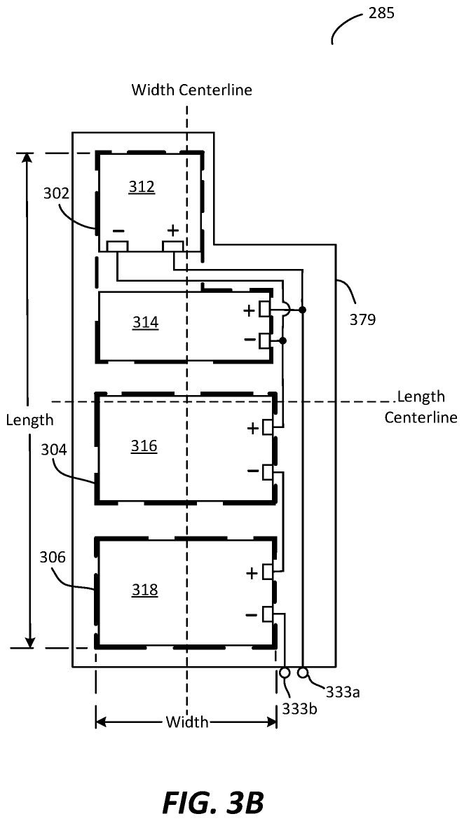

FIG. 3A illustrates an overhead view of one exemplary embodiment of an asymmetric battery cell block configuration 285 of a battery system 165 as it may be mechanically coupled in one embodiment to an optional printed circuit board (PCB) 325 that is shown in dashed outline. In FIG. 3A, asymmetric battery cell block configuration 285 is defined by multiple battery cell blocks 302, 304, and 306 that are coupled together in series as shown, with length (longer axis) and width (shorter axis) of the battery cell configuration 285 being as shown. In this embodiment, battery cell block 304 includes a single battery cell 316, battery cell block 306 includes a single battery cell 318, and battery cell block 302 is a mixed cell block that includes multiple battery cells 312 and 314 that are electrically coupled together in parallel with each other within battery cell block 302 as shown. In this embodiment, the individual battery cells 312 and 314 of battery cell block 302 have different battery cell charge capacities and at least different areal physical sizes (i.e., length-by-width) than each of the battery cells 316 and 318 of respective battery cell blocks 304 and 306. It will be understood in one embodiment that the height (i.e., thickness) of each of battery cells 312, 314, 316 and 318 may be the same, and that in other embodiments the height of any one or more of battery cells 312, 314, 316 and 318 may be different from the height of any one or more of the other battery cells of battery system 165.

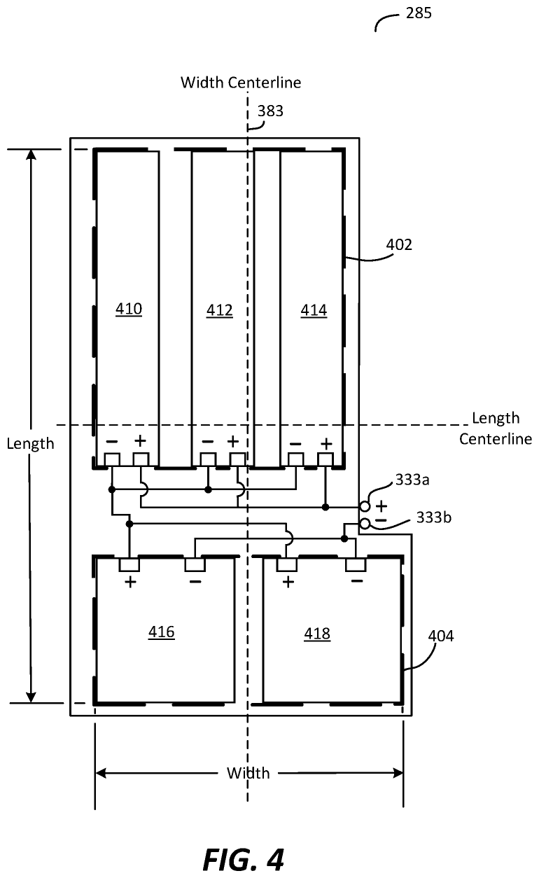

In one embodiment shown in FIG. 3A, each of battery cell blocks 302, 304 and 306 may be optionally contained within an enclosure (e.g., plastic or metal case) that has external positive and negative terminals for electrical coupling to the electrical terminals of other battery cell blocks of asymmetric battery cell block configuration 285 and the positive and negative electrical terminals 333a and 333b of asymmetric battery cell block configuration 285 as shown. In an alternative embodiment, the battery cells 312, 314, 316 and 318 of each of battery cell blocks 302, 304 and 306 may not be so enclosed, in which case the length and width of the asymmetric battery cell block configuration 285 may be defined by the outer side dimensions of the battery cells 312, 314, 316 and 318 themselves (as shown in FIGS. 3B and 4).

In one embodiment, the rated nominal voltage of battery cells 312 and 314 of battery cell block 302 may be the same (e.g., 3 volts) as the respective rated nominal voltage of each of battery cells 316 and 318 of battery cell block 304. Additionally, the combined charge capacity of battery cells 312 and 314 of battery cell block 302 may be the same as the respective charge capacities of each of battery cell 316 of battery cell block 304 and battery cell 318 of battery cell block 306. For example, the charge capacity of battery cell 312 of battery cell block 302 may be 12 watt-hours, the charge capacity of battery cell 314 of battery cell block 302 may be 7 watt-hours, and the charge capacity of each of battery cell 316 of battery cell block 304 and battery cell 318 of battery cell block 306 may be 19 watt-hours. This results in the same charge capacity of 19 watt-hours for each of serially-coupled battery cell blocks 302, 304 and 306; and a total combined battery cell block charge capacity of 57 watt-hours for battery cell block configuration 285. It will be understood that the battery cell nominal voltage and charge capacities of this example are exemplary only, and that greater or lesser battery cell nominal voltages are possible, and/or that each of battery cells 312, 314, 316 and 318 may have a greater or lesser charge capacity such that each of the serially-coupled battery cell blocks 302, 304 and 306 have the same rated nominal voltage and charge capacity.

As shown in FIG. 3A, no axis of length or width symmetry exists with regard to battery cell physical size and/or battery cell charge capacity of asymmetric battery cell block configuration 285. As shown, battery cell blocks 302, 304 and 306 of FIG. 3A are positioned such that battery cell block configuration 285 is asymmetric about a length centerline 381 that extends through battery cell block configuration 285 and is also asymmetric about a width centerline 383 that extends through battery cell block configuration 285. Furthermore, battery cell blocks 302, 304 and 306 are positioned such that battery cell block configuration 285 is also asymmetric about any line extending through any serial electrical coupling (e.g., serial electrical connection) between any two adjacent multiple battery cell blocks of battery cell block configuration 285.

In this embodiment, multiple battery cell blocks 302, 304, and 306 have the same total block charge capacity relative to each other. For example, each of multiple battery cell blocks 302, 304, and 306 may have a total block charge capacity of 19 watt-hours (Whr), although each of multiple battery cell blocks 302, 304, and 306 may have any other greater or lesser total block charge capacity that is equal to the other battery cell blocks and that provides a needed total charge capacity for the asymmetric battery cell block configuration 285.

It will be understood that the number of parallel-coupled battery cells within battery cell block 302 of FIG. 3A is exemplary only, and that in other embodiments a battery cell block may include greater than two battery cells coupled in parallel. It will also be understood that the number of battery cell blocks coupled together in series within an asymmetric battery cell block configuration 285 may vary, e.g., battery cell block 302 may be coupled in series to only one other battery cell block of equal charge capacity or may be coupled in series to more than two other battery cell blocks of equal charge capacity. For example, battery cell block 302 may be coupled to only one other battery cell block that includes only a single battery cell of equal charge capacity to the combined charge capacity of battery cells 312 and 314 of battery cell block 302.

Still referring to the exemplary embodiment of FIG. 3A, battery cells 312 and 314 of battery cell block 302 have different battery cell capacities and at least different physical arcal sizes (i.e., at least different length-by-width or upper (top) surface area sizes in this illustrated embodiment) relative to each other. For example, battery cell 312 may have a cell charge capacity of 12 watt-hours and battery cell 314 may have a cell charge capacity of 7 watt-hours, i.e., to give battery cell block 302 a total block charge capacity of 19 watt-hours, although each of battery cells 312 and 314 may have any other greater or lesser cell charge capacity that is different from the cell charge capacity of the other one of battery cells 312 and 314, and that results in a needed total block charge capacity for battery cell block 302 that is equal to the total block charge capacity (e.g., 19 watt-hours) of each of the other battery cell blocks 304 and 306. It will be understood that each of

As shown in FIG. 3A, each of multiple battery cell blocks 302, 304, and 306 of asymmetric battery cell block configuration 285 may be optionally mechanically coupled (e.g., using adhesive and/or fasteners such as bolts or screws to an optional printed circuit board (PCB) 325 which is illustrated in dashed outline. In the illustrated embodiment, PCB 325 has irregular outside dimensions, e.g., narrower at the top and wider at the bottom as shown. As further shown in FIG. 3A, external areal boundaries (areal footprint) of battery cell blocks 302, 304 and 306 are complementary in physical size (e.g., areal shape and dimensions) to the external arcal boundary dimensions (areal footprint) of PCB 325 such that each of battery cell blocks 302, 304 and 306 fit closely within the perimeter boundaries of PCB 325 without leaving excess vacant area of PCB 325 exposed between the outer boundaries of PCB 325 and any of battery cell blocks 302, 304 and 306, i.e., the combined form factor of asymmetric battery cell block configuration 285 corresponds to and overlies or covers substantially all of the upper surface form factor of PCB 325.

In one exemplary embodiment, the plane of PCB 325 of FIG. 3A may be installed within an information handling system 100 such that it is oriented parallel to the plane of the footprint of the information handling system 100, e.g., the plane of PCB 325 may be oriented parallel to the plane of the planar base and keyboard of a notebook computer within which it is installed. In another exemplary embodiment, the plane of PCB 325 may be installed within an information handling system 100 such that it is oriented parallel to the plane of a motherboard PCB that is also installed within the information handling system 100.

In the embodiment of FIG. 3A, the combination of narrower battery cell 312 and wider battery cell 314 within battery cell block 302 allows the external geometry and dimensions of battery cell block 302 to be configured to fit closely within the outer boundaries of the upper portion of PCB 325 as shown. This allows for a more efficient use or coverage of the surface area form factor of PCB area 325 (e.g., a greater coverage or use of the surface area of the form factor of PCB 325) than would be possible if the battery cells of battery cell block 302 all had the same physical size (shape and physical dimensions) and/or if all of the battery cells of battery cell blocks 302, 304 and 306 had the same physical size (shape and physical dimensions) as each other, i.e., in which case a relatively larger surface area of the form factor of PCB 325 would be left uncovered by battery cell blocks.

In other embodiments (e.g., that do not include an optional PCB 325), a more efficient use of available area (space) and/or volume within a cavity inside an information handling chassis may be similarly achieved by selecting and providing the physical size (shape and physical dimensions) of one or more battery cell blocks so as to assemble an asymmetric battery cell block configuration 285 that fits closely within the available space and/or volume within the cavity.

In either case (e.g., PCB 325 present or not), the narrower battery cell 312 allows asymmetric battery cell block configuration 285 to be configured with a narrower width at its upper end as shown in FIGS. 3A and 3B. When installed as part of a battery system 165 within an information handling system 100, this narrower upper end width of asymmetric battery cell block configuration 285 provides open space for the placement of other adjacent internal components (e.g., such as a touchpad, etc.) of information handling system 100 next to battery cell 312 at the narrower upper end of asymmetric battery cell block configuration 285. At the same time, the presence of a wider battery cell 314 within battery cell block 302, together with wider battery cells 316 and 318 within battery cell blocks 304 and 306, also provides for an increased total combined battery cell block charge capacity that is provided by asymmetric battery cell block configuration 285 for powering the power-consuming circuitry of the information handling system 100.

FIG. 3B illustrates an overhead view of one exemplary embodiment of an asymmetric battery cell block configuration 285 of a battery system 165 as it may be implemented using the same battery cells 312, 314, 316 and 318 as in FIG. 3A, but in this case battery cells 312, 314, 316 and 318 are not separately enclosed, but instead are all contained within a single enclosure (e.g., plastic or metal case), for example as a replaceable or non-replaceable battery pack. In FIG. 3B, asymmetric battery cell block configuration 285 is defined by serially-coupled multiple battery cell blocks 302, 304, and 306 that are delineated in FIG. 3B by dark dashed lines. In this regard, multiple battery cell blocks 302, 304, and 306 are coupled together in series as shown, with length and width of the battery cell configuration 285 within single enclosure (e.g., metal or plastic enclosure) 379 being as shown. Similar to the embodiment of FIG. 3A, battery cell block 304 includes a single battery cell 316, battery cell block 306 includes a single battery cell 318, and battery cell block 302 includes multiple battery cells 312 and 314 that are electrically coupled together in parallel with each other within battery cell block 304 as shown.

FIG. 4 illustrates an overhead view of another exemplary embodiment of an asymmetric battery cell block configuration 285 of a battery system 165 that is defined by multiple battery cell blocks 402 and 404 (i.e., delineated in FIG. 4 by bold dashed lines) that are coupled together in series within a single enclosure (e.g., metal or plastic enclosure) 479, with length and width of the battery cell configuration 285 of FIG. 4 being as shown. In this embodiment, battery cell block 402 contains multiple battery cells 410, 412 and 414 that are electrically coupled together in parallel with each other within battery cell block 402, and battery cell block 404 contains multiple battery cells 416 and 418 that are electrically coupled together in parallel with each other within battery cell block 404 as shown.

In the embodiment of FIG. 4, each of the individual battery cells 410, 412 and 414 of battery cell block 402 has a battery cell charge capacity and physical areal size (physical areal shape and physical areal dimensions) that is different from the physical areal size of each of individual battery cells 416 and 418 of battery cell block 404. Also, in this embodiment, the individual battery cells 410, 412 and 414 of battery cell block 402 have the same battery cell charge capacity and physical areal size as each other, and the individual battery cells 416 and 418 of battery cell block 404 have the same battery cell charge capacity and physical areal size as each other.

As with the embodiment of FIG. 3, the rated nominal voltage of battery cells 410, 412 and 414 of battery cell block 402 of FIG. 4 may be the same (e.g., 3 volts or other suitable greater or lesser voltage) as the respective rated nominal voltage of each of battery cells 416 and 418 of battery cell block 304. Additionally, the combined charge capacity of battery cells 410, 412 and 414 of battery cell block 402 may be the same as the combined charge capacity of each of battery cells 416 and 418 of battery cell block 404. For example, the charge capacities of each of battery cells 410, 412 and 414 of battery cell block 402 may be 10 watt-hours, and the charge capacities of each of battery cells 416 and 418 of battery cell block 404 may be 15 watt-hours. This results in the same charge capacity of 30 watt-hours for each of serially-coupled battery cell blocks 402 and 404; and a combined battery cell block charge capacity of 60 watt-hours for battery cell block configuration 285. It will be understood that the battery cell nominal voltage and charge capacities of this example are exemplary only, and that greater or lesser battery cell nominal voltages are possible.

As shown in FIG. 4, no axis of length or width symmetry exists with regard to battery cell physical size and/or battery cell charge capacity of asymmetric battery cell block configuration 285. As shown, battery cell blocks 402 and 404 of FIG. 4 are positioned such that battery cell block configuration 285 is asymmetric about a length centerline 481 that extends through battery cell block configuration 285 and is also asymmetric about a width centerline 483 that extends through battery cell block configuration 285. Furthermore, battery cell blocks 402 and 404 are positioned such that battery cell block configuration 285 is also asymmetric about a line extending through the serial electrical coupling (e.g., serial electrical connection) between any battery cell blocks 402 and 404 of battery cell block configuration 285.

It will be understood that the numbers of parallel-coupled battery cells within serially-coupled battery cell blocks 402 and 404 of FIG. 4 are exemplary only, and that in other embodiments a first battery cell block may include any number of multiple battery cells coupled together in parallel that differs from any other number of multiple battery cells of a second battery cell block that are coupled together in parallel. It will also be understood that the number of battery cell blocks containing multiple parallel-coupled battery cells that are coupled together in series may vary within an asymmetric battery cell block configuration 285, e.g., battery cell block 402 may be coupled in series to two or more other battery cell blocks of equal charge capacity.

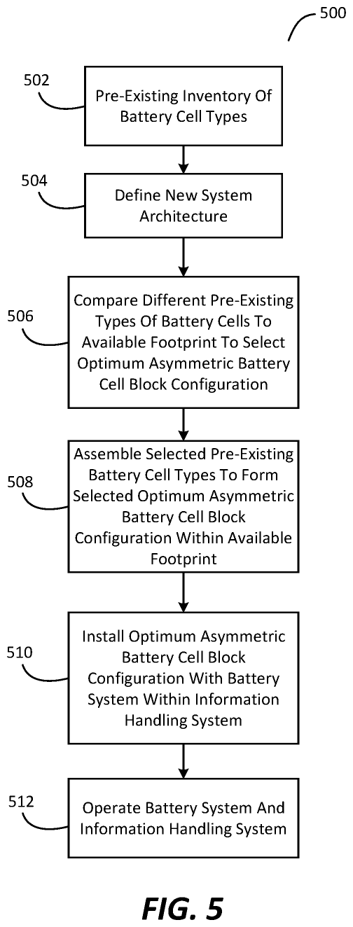

FIG. 5 illustrates one exemplary embodiment of a methodology 500 that may be employed to assemble an asymmetric battery cell block configuration 285 of a battery system 165 for powering an information handling system 100. For purposes of illustration, FIG. 5 is described below with reference to the embodiment of FIG. 3A. However, it will be understood that a similar methodology may be employed to assemble different asymmetric battery cell block configurations, e.g., having greater or lesser number of cell blocks that illustrated in FIG. 3A and/or having different number of battery cells within any given cell block of FIG. 3A. For example, such different asymmetric battery cell block configurations include, but are not limited to, those asymmetric battery cell block configurations illustrated and described in relation to FIGS. 3B and 4 herein.

As shown, methodology 500 begins in box 502 where a pre-existing inventory of different types of battery cells is previously manufactured and maintained in warehouse storage. These different types of pre-existing battery cells each have a rated nominal voltage (e.g., with all of the multiple battery cell types having the same rated nominal voltage, or with at least a plurality of the multiple battery cell types having the same rated nominal voltage). These different types of pre-existing battery cells also each have at least different respective physical sizes (e.g., different physical shapes and/or different physical dimensions) and/or different respective individual battery cell charge capacities relative to each other. To illustrate, in one example, a pre-existing inventory different battery cell types may include at least the three different types of battery cells 312, 314 and 316 (i.e., which is the same type as 318) that are illustrated and described in relation to FIG. 3A.

Next, after completion of box 502, a new system architecture is designed or otherwise defined in box 504 for a battery system 165 of an information handling system 100 that has a limited available internal space of specific shape and dimensions that is available for receiving and containing the new system architecture of battery system 165. The new system architecture of battery system 165 may include available battery cell block space of specific shape and dimensions (e.g., including a limited available upper surface area or areal footprint) that is available for receiving and containing battery cells for the battery system 165, and that will fit within the limited available internal space of information handing system 100.

As just one example, the outer boundary (e.g., shape and dimensions) of PCB 325 of FIG. 3A defines an outer boundary of an upper surface area or areal footprint of battery cell block space that is available for placing and assembling together battery cells of multiple battery cell blocks on PCB 325 for the newly designed battery system architecture of box 504, e.g., that itself will fit within an internal space defined within an outer chassis enclosure of a specific information handling system 100 (e.g., tablet computer body or smartphone body, hinged notebook computer base, etc.). In box 504, the new system architecture may also include a selected rated nominal voltage and total combined battery cell block charge capacity that is required for the new system architecture to satisfactorily power the information handling system 100.

Next, in box 506, the different physical sizes and/or different individual battery cell charge capacities of the pre-existing inventory of available battery cells from box 502 may be compared to the respective required total combined battery cell block charge capacity and/or the specific shape and dimensions of the available battery cell block space of the newly defined system architecture from box 504. For example, in the embodiment of FIG. 3A, the available battery cell block space of a newly defined system architecture is the footprint (e.g., of PCB 325) that is available for receiving battery cells for the newly designed battery system architecture of box 504.

This comparison of box 506 may be made in order to determine at least one asymmetric battery cell block configuration 285 of the multiple pre-existing battery cells that will fit together within the available battery cell block space of the new system architecture (e.g., the outer boundary of the available battery cell footprint) from box 504 and that may be electrically coupled together to provide the rated nominal voltage and total combined battery block charge capacity needed for the newly designed battery system architecture of box 504.

Where more than one different asymmetric battery cell block configurations 285 is possible in box 506, a selected criteria for the battery system (e.g., such as achieving greatest total combined battery cell block charge capacity for the battery system, achieving lowest combined battery cell cost for the battery system, achieving lightest weight of combined battery cells for the battery system, etc.) may be applied to select an optimum asymmetric battery cell block configuration 285 of multiple battery cells that optimizes (e.g., best matches) the selected criteria. For example, in the embodiment of FIG. 3A, available pre-existing battery cell types 312, 314 and 316/318 may be selected and assembled into an asymmetric battery cell block configuration 285 made up of multiple battery cell blocks 302, 304 and 306 that most completely fill (or cover the upper surface area of) the available battery cell areal footprint within the outer boundary of PCB 325, e.g., in order to achieve and optimize a selected criteria of the greatest total combined battery cell block charge capacity assembled within the available battery cell block space of the newly defined system architecture from box 504.

Next, in box 508, the corresponding selected multiple battery cell types of the selected optimum asymmetric battery cell block configuration 285 from box 506 are physically assembled together as battery cell blocks within the available battery cell block space of the newly defined system architecture, such as the available battery cell areal footprint (e.g., within the outer boundary of PCB 325), and electrically coupled together in a manner to form the selected optimum asymmetric battery cell block configuration 285 having the required nominal rated voltage and total combined battery cell block charge capacity needed for the newly designed battery system architecture of box 504. For example, multiple different-physical sized and/or different charge capacity battery cells may be built up (e.g., and electrically coupled in parallel) into a first battery cell block, and then the built-up first battery cell block may be electrically coupled in series to one or more other cell blocks (e.g., each containing a single battery cell or multiple battery cells electrically coupled in parallel) that have the same battery cell block charge capacity to form an asymmetric battery cell block configuration 285. To illustrate, in the example of FIG. 3A, selected multiple battery cell types corresponding to battery cells 312, 314, 316 and 318 are electrically coupled together as battery cell blocks 302, 304 and 306 in a manner (e.g., a combination of parallel and serial electrical couplings) described in relation to FIG. 3A to the selected optimum asymmetric battery cell block configuration 285 of FIG. 3A having the required nominal rated voltage and required total combined battery cell block charge capacity for the newly designed battery system architecture of box 504.

Next, in box 510, the assembled optimum asymmetric battery cell block configuration 285 of box 508 is installed within the outer chassis enclosure of the specific information handling system 100, and electrically coupled to circuitry of a battery system 165 and circuitry of an information handling system 100, e.g., in the manner illustrated and described in relation to FIGS. 1 and 2. It will be understood that in one exemplary embodiment, some or all of the tasks of boxes 508 and 510 may be performed together, e.g., in the case where one or more components of a battery system 165 are assembled and/or electrically coupled together within an information handling system 100.

Next, in box 512, the assembled circuitries of a battery system 165 and an information handling system 100 are operated together using power supplied from the assembled optimum asymmetric battery cell block configuration 285, e.g., in a manner as illustrated and described in relation to FIGS. 1 and 2.

It will be understood that the identity and sequence of boxes of FIG. 5 are exemplary only, and that any combination of fewer, additional and/or alternative boxes may be employed that are suitable for assembling an asymmetric battery cell block configuration of a battery system for powering an information handling system 100.

It will also be understood that one or more of the tasks, functions, or methodologies described herein (e.g., including those described herein for components 105, 106, 111, 115, 125, 135, 145, 154, 160, 165, 183, etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program includes instructions that are configured when executed on a processing device in the form of a programmable integrated circuit (e.g., processor such as CPU, controller, microcontroller, microprocessor, ASIC, etc. or programmable logic device “PLD” such as FPGA, complex programmable logic device “CPLD”, etc.) to perform one or more boxes of the methodologies disclosed herein. In one embodiment, a group of such processing devices may be selected from the group consisting of CPU, controller, microcontroller, microprocessor, FPGA, CPLD and ASIC. The computer program of instructions may include an ordered listing of executable instructions for implementing logical functions in an processing system or component thereof. The executable instructions may include a plurality of code segments operable to instruct components of an processing system to perform the methodologies disclosed herein.

It will also be understood that one or more boxes of the present methodologies may be employed in one or more code segments of the computer program. For example, a code segment executed by the information handling system may include one or more boxes of the disclosed methodologies. It will be understood that a processing device may be configured to execute or otherwise be programmed with software, firmware, logic, and/or other program instructions stored in one or more non-transitory tangible computer-readable mediums (e.g., data storage devices, flash memories, random update memories, read only memories, programmable memory devices, reprogrammable storage devices, hard drives, floppy disks, DVDs, CD-ROMs, and/or any other tangible data storage mediums) to perform the operations, tasks, functions, or actions described herein for the disclosed embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A battery system, comprising:
multiple battery cell blocks electrically coupled together in series;
where all of the battery cell blocks of the battery system together form an asymmetric configuration of multiple battery cell blocks;
where each of the battery cell blocks comprises one or more battery cells; and
where each of the battery cell blocks has a total block charge capacity that is the same as a total block charge capacity of each of the other battery cell blocks.

2. The battery system of claim 1, where at least a first one of the multiple battery cell blocks has a first internal battery cell configuration that is different from a second internal battery cell configuration of at least a second one of the other multiple battery cell blocks of the battery system.

3. The battery system of claim 1, where the multiple cell blocks are positioned such that the asymmetric configuration of multiple battery cell blocks has no axis of length symmetry or axis of width symmetry with regard to battery cell physical size and/or battery cell charge capacity.

4. The battery system of claim 1, where an overall configuration of all of the battery cell blocks of the battery system taken together is at least one of asymmetric about a centerline that extends through a length of the overall configuration of all of the battery cell blocks of the battery system or asymmetric about a centerline that extends through a width of the overall configuration of all of the battery cell blocks of the battery system.

5. The battery system of claim 1, where an overall configuration of all of the battery cell blocks of the battery system taken together is at least one of asymmetric about any line that extends through a length of the overall configuration of all of the battery cell blocks of the battery system or asymmetric about any line that extends through a width of the overall configuration of all of the battery cell blocks of the battery system.

6. The battery system of claim 1, where an overall configuration of all of the battery cell blocks of the battery system taken together is asymmetric about any line extending through any serial electrical coupling between any two adjacent battery cell blocks of the of all of the battery cell blocks of the battery system.

7. The battery system of claim 1, where at least a first one of the multiple battery cell blocks has a first internal battery cell configuration that includes multiple battery cells that are electrically coupled together in parallel; and where at least a second one of the other multiple battery cell blocks has a second internal battery cell configuration that includes only a single battery cell.

8. The battery system of claim 7, where the battery system has opposing first and second ends; where the first battery cell block is positioned nearer the first end of the battery system than is the second battery cell block; where the second battery cell block is positioned nearer the opposing second end of the battery system than is the first battery cell block; and where an overall configuration of all of the battery cell blocks of the battery system taken together is asymmetric about any line that extends through the length or width of the overall configuration of all of the battery cell blocks of the battery system to separate the first battery cell block from the second battery cell block.

9. The battery system of claim 1, where the multiple battery cell blocks of the battery system comprise at least first and second battery cell blocks; where the first battery cell block of the multiple battery cell blocks comprises multiple battery cells that each have an individual cell physical size and an individual cell charge capacity; and where at least one of:
the second battery cell block comprises at least one battery cell that has a different individual cell physical size and a different individual cell charge capacity than the individual cell physical size and the individual cell charge capacity of any of the multiple battery cells of the first battery cell block, or
the second battery cell block comprises multiple battery cells that differ in total number from a total number of the multiple battery cell blocks of the first battery cell block and the multiple battery cells of the second battery cell block have individual cell physical sizes that differ from the individual cell physical size of any of the multiple battery cells of the first battery cell block.

10. The battery system of claim 1, where the multiple battery cell blocks of the battery system comprise at least first and second battery cell blocks; where the first battery cell block comprises multipole battery cells electrically coupled together in parallel; where the second battery cell block comprises one or more battery cells that are not equal in number to the number of battery cells of the first battery cell block; and where none of the battery cells of the second battery cell block have the same physical size as the physical size of any of the battery cells of the first battery cell block.

11. An information handling system, comprising:
power-consuming circuitry that comprises at least one programmable integrated circuit; and
a battery system electrically coupled to provide power to the power-consuming circuitry, the battery system comprising multiple battery cell blocks electrically coupled together in series;
where all of the battery cell blocks of the battery system together form an asymmetric configuration of multiple battery cell blocks;
where each of the battery cell blocks of the battery system comprises one or more battery cells; and
where each of the battery cell blocks of the battery system has a total block charge capacity that is the same as a total block charge capacity of each of the other battery cell blocks of the battery system.

12. The information handling system of claim 11, where at least a first one of the multiple battery cell blocks of the battery system has a first internal battery cell configuration that is different from a second internal battery cell configuration of at least a second one of the other multiple battery cell blocks of the battery system; and where the multiple cell blocks of the battery system are positioned such that the asymmetric configuration of multiple battery cell blocks has no axis of length symmetry or axis of width symmetry with regard to battery cell physical size and/or battery cell charge capacity.

13. The information handling system of claim 11, where an overall configuration of all of the battery cell blocks of the battery system taken together is at least one of asymmetric about any line that extends through a length of the overall configuration of all of the battery cell blocks of the battery system or asymmetric about any line that extends through a width of the overall configuration of all of the battery cell blocks of the battery system.

14. The information handling system of claim 11, where at least a first one of the multiple battery cell blocks has a first internal battery cell configuration that includes multiple battery cells that are electrically coupled together in parallel; and where at least a second one of the other multiple battery cell blocks has a second internal battery cell configuration that includes only a single battery cell; where the battery system has opposing first and second ends; where the first battery cell block is positioned nearer the first end of the battery system than is the second battery cell block; where the second battery cell block is positioned nearer the opposing second end of the battery system than is the first battery cell block; and where an overall configuration of all of the battery cell blocks of the battery system taken together is asymmetric about any line that extends through the length or width of the overall configuration of all of the battery cell blocks of the battery system to separate the first battery cell block from the second battery cell block.

15. The information handling system of claim 11, where the multiple battery cell blocks of the battery system comprise at least first and second battery cell blocks; where the first battery cell block of the multiple battery cell blocks comprises multiple battery cells that each have an individual cell physical size and an individual cell charge capacity; and where at least one of:
the second battery cell block comprises at least one battery cell that has a different individual cell physical size and a different individual cell charge capacity than the individual cell physical size and the individual cell charge capacity of any of the multiple battery cells of the first battery cell block, or
the second battery cell block comprises multiple battery cells that differ in total number from a total number of the multiple battery cell blocks of the first battery cell block and the multiple battery cells of the second battery cell block have individual cell physical sizes that differ from the individual cell physical size of any of the multiple battery cells of the first battery cell block.

16. The information handling system of claim 11, where the multiple battery cell blocks of the battery system comprise at least first and second battery cell blocks; where the first battery cell block comprises multipole battery cells electrically coupled together in parallel; where the second battery cell block comprises one or more battery cells that are not equal in number to the number of battery cells of the first battery cell block; and where none of the battery cells of the second battery cell block have the same physical size as the physical size of any of the battery cells of the first battery cell block.

17. The information handling system of claim 11, where the information handling system is a mobile portable information handling system.

18. A method, comprising:
manufacturing multiple battery cell types, each of the manufactured multiple battery cell types having at least one of a different respective physical size or a different respective battery cell charge capacity relative to the other manufactured battery cell types;
then defining a new battery system architecture for an information handling system that has a limited internal space available for receiving and containing the new battery system architecture, the new battery system architecture having an available battery cell block space and a required total combined battery cell block charge capacity for powering power-consuming circuitry of the information handling system;
then comparing the respective physical sizes and the respective battery cell charge capacities of the manufactured multiple battery cell types to the required total combined battery cell block charge capacity and the available battery cell block space of the new system architecture to determine a selected asymmetric battery cell block configuration of the manufactured multiple battery cell types that fit together within the available battery cell block space of the new system architecture and that will provide the required total combined battery cell block charge capacity for powering the power-consuming circuitry of the information handling system;
then physically assembling together the manufactured multiple battery cell types of the selected asymmetric battery cell block configuration to form an assembled asymmetric battery cell block configuration comprising multiple battery cell blocks that are electrically coupled together in series within the limited available internal space of the information handling system, and with the assembled asymmetric battery cell block configuration being electrically coupled to the power-consuming circuitry of the information handling system; and
then providing power from the assembled asymmetric battery cell block configuration to operate the power-consuming circuitry of the information handling system;
where each of the battery cell blocks of the asymmetric battery cell block configuration comprises one or more battery cells; and
where each of the battery cell blocks of the asymmetric battery cell block configuration has a total block charge capacity that is the same as a total block charge capacity of each of the other battery cell blocks.

19. The method of claim 18, where at least a first one of the multiple battery cell blocks of the battery system has a first internal battery cell configuration that is different from a second internal battery cell configuration of at least a second one of the other multiple battery cell blocks of the battery system; and where the multiple cell blocks of the battery system are positioned such that the asymmetric configuration of multiple battery cell blocks has no axis of length symmetry or axis of width symmetry with regard to battery cell physical size and/or battery cell charge capacity.

20. The method of claim 18, where the information handling system is a mobile portable information handling system.
